(19) United States
(12) Patent Application Publication
(10) Pub. No.: US 2021/0089897 A1
(43) Pub. Date: Mar. 25, 2021

(54) HIGH-RESOLUTION EARTH MODELING USING ARTIFICIAL INTELLIGENCE

(71) Applicant: QUANTICO ENERGY SOLUTIONS LLC, 77041, TX (US)

(72) Inventors: Barry F. ZHANG, Houston, TX (US); Yasser Mosaad Ahmed MOHAMED, Spring, TX (US); Orlando DE JESUS, Frisco, TX (US); Michael COSTELLO, Katy, TX (US)

(21) Appl. No.: 17/002,161

(22) Filed: Aug. 25, 2020

Related U.S. Application Data
(60) Provisional application No. 62/905,008, filed on Sep. 24, 2019.

(51) Int. Cl. G06N 3/08; G06N 3/04

(52) U.S. Cl. CPC G06N 3/08; G06N 3/04

(57) ABSTRACT

Aspects of the present disclosure relate to using artificial intelligence for high-resolution earth modeling. Embodiments include receiving training data, comprising: wellbore attributes relating to a plurality of depth points; and adjacent waveform data relating to a first plurality of directions with respect to each depth point of the plurality of depth points. Embodiments include providing at least a subset of the training data as inputs to a machine learning model. Embodiments include receiving outputs from the machine learning model based on the inputs. Embodiments include iteratively adjusting parameters of the machine learning model based on the outputs and the training data.

### RELATED APPLICATIONS

This application claims the benefit of U.S. Provisional Application No. 62/905,008, entitled “HIGH-RESOLUTION EARTH MODELING USING ARTIFICIAL INTELLIGENCE,” filed 24 Sep. 2019, the contents of which are incorporated herein by reference in their entirety.

### BACKGROUND OF THE DISCLOSURE

### Field of the Disclosure

The present disclosure generally relates to the use of artificial intelligence for earth modeling.

### Description of the Related Art

Earth models are well recognized as a preferred means of creating and optimizing well paths, as they allow a user to visualize the geology at an intended wellbore landing zone, as well as zones above and below that may present hazards or other drilling opportunities. However, earth models are often cumbersome to deal with and require complex proprietary software and specialized expertise to manipulate.

Traditional earth models are typically created through a seismic inversion process that can be difficult and time consuming. Seismic inversion generally requires a high level of expertise and conditioned seismic data with proper offset well logs as inputs, which are often limited in supply. In addition, the entire process of generating a seismic inversion is generally very expensive, and suffers from accuracy issues depending on the vintage of the survey and design parameters. Furthermore, manually harmonizing structural interpretations between earth models and seismic volumes is a difficult process.

Some techniques involve the use of machine learning models as a complement to inversion earth models. However, both manual methods and conventional techniques involving machine learning models have limitations, such as limited sampling and, most importantly, lack of training data.

### SUMMARY OF THE DISCLOSURE

The present disclosure generally relates to using artificial intelligence for high-resolution earth modeling. Certain embodiments include training a model based on a set of training data comprising at least a subset of: well logs, seismic volumes (both pre and post-stack), geologic maps, initial information from wells, core data, horizons, seismic images, synthetic log data, and the like. In certain embodiments, training data for training the model includes attributes at each of a plurality of depth points along with adjacent waveforms in a plurality of directions at each depth point. Some embodiments involve using waveforms in a forward, backward, left, right, upward, and/or downward direction in three-dimensional space along with attributes at a given depth point for training data. The model may, for example, be a machine learning model such as an artificial neural network, deep neural network, deep belief network, recurrent neural network, convolutional neural network, or the like that is trained using machine learning methods. Once trained, the model is used to determine various output parameters such as reservoir properties including lithology, porosity, permeability, water saturation, impedance (p or s), density, and the like. Accordingly, high-resolution earth models may be efficiently generated based on outputs from the model, and the improved earth models can be used to optimize well placement and mitigation of drilling hazards, and as the well is being drilled, the earth model can be updated in real-time or within a few hours of real-time to ensure the well is landed in and staying in the desired zone, is utilizing adequate mud weights to avoid dangerous wellbore instability events, and avoiding certain geologic hazards such as faults.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 illustrates an example related to high-resolution earth modeling using artificial intelligence.

FIG. 2 illustrates an additional example related to high-resolution earth modeling using artificial intelligence.

FIG. 3 illustrates example operations for training a model related to high-resolution earth modeling.

FIG. 4 illustrates example operations for using a trained model for high-resolution earth modeling.

FIG. 5 illustrates improved results obtained by using embodiments of the present disclosure for high-resolution earth modeling as compared to conventional techniques.

FIG. 6 illustrates an example of a computing system with which embodiments of the present disclosure may be implemented.

### DETAILED DESCRIPTION

Embodiments of the present disclosure relate to using artificial intelligence for high-resolution earth modeling. For example, a machine learning model may be trained using training data including historical measurements captured during past drilling operations and/or exploratory measurements taken during exploratory operations, as well as information derived from this data, and the trained model may be used to generate and update high-resolution earth models in real-time or within a few hours of real-time based on measurements taken while drilling.

A neural network (sometimes referred to as an artificial neural network or ANN) is generally based on a biological brain, and includes a plurality of interconnected nodes or “neurons”. Each node generally has one or more inputs with associated weights, a net input function, and an activation function. Nodes are generally included in a plurality of connected layers, where nodes of one layer are connected to nodes of another layer, with various parameters governing the relationships between nodes and layers and the operation of the neural network. A shallow neural network generally includes only a small number of “hidden” layers between an input layer and an output layer. By contrast, a deep learning model, such as a deep neural network, deep belief network, recurrent neural network, or convolutional neural network, generally includes a larger number of hidden layers.

In certain embodiments, the model uses multiple inputs to generate one or multiple outputs. The inputs can be taken at the same or different depths (or times) of the outputs to be produced. The individual inputs (e.g., p₁,p₂, . . . ,p_{R}) are weighted by the corresponding elements (e.g., w_{1,1}, w_{1,2}, . . . , w_{1,R}) of the weight matrix W. Each neuron has a bias b, which is summed with the weighted inputs to form the net input n=Wp+b. The net input n is then applied to a transfer function ƒ. The transfer function can be a linear or nonlinear function of n. A particular transfer function is selected based on the problem to solve. Typical transfer functions are linear, hard limit, hyperbolic Tangent Sigmoid (tan sig), Log-Sigmoid (log sig) or Competitive functions. The output of a neuron a can be defined as a=ƒ(Wp+b).

A single-layer network of S neurons will operate over a vector of inputs p to generate an output a, while a combination of layers will create a multilayer neural network. A layer whose output is the network output is the output layer. The other layers are called hidden layers. After the architecture is defined, the next step is training the multilayer neural network. One example training method is called backpropagation, which is a generalization of the Least Mean Square error or LMS algorithm. Backpropagation is an approximate steepest descent algorithm, in which the performance index is mean square error. The general steps are: propagate the inputs forward to the network, then calculate the sensitivities backward through the network and use the sensitivities to update the weights and biases using a steepest descent rule. The process is repeated until the objective function is minimized, a number of iterations is executed or the error of an alternate set of data increases after a few iterations.

Neural networks are a technology well-suited to finding the non-linear correlations that exist among large data sets. Neural networks have been applied in certain contexts related to oil and gas exploration, including litho-faces analysis, detection of microseismic events, pseudo seismic inversion, and the like.

In the present solution, inputs used to train a machine learning model such as a neural network may comprise a wide variety of information types, including well logs, seismic volumes (both pre and post-stack), geologic maps, initial information from wells, core data, horizons, seismic images, synthetic log data, gamma, temperature, torque, differential and standpipe pressure, mud weight, and the like. In some embodiments, attributes from different depth points are used as training data along with adjacent waveforms from a plurality of directions (e.g., above, below, to the sides such as left and right, forward, and/or backward) with respect to each depth point. In one embodiment, the attributes include a combination of gamma, resistivity, neutron, density, compressional, and shear logs.

Supervised training methods generally involve providing training inputs to a model and comparing outputs of the model to labels that have been assigned to the training inputs, iteratively adjusting parameters of the model until the outputs match the labels. Labels correspond to parameters that are output by the model, and represent actual “known” values for these parameters for a given set of training inputs. For example, labels may be assigned to a given set of training inputs based on a correlation between the given set of training inputs and a particular value for a parameter that was measured or determined at the time the training inputs were measured or determined. Parameters output by the model may include, for example, rock properties and geo-mechanics, density, acoustic impendence and velocity, stress, brittleness, Young's and Poisson's Modulus, pore pressure attributes, wellbore stability, petro-physical properties, and/or the like.

In certain embodiments, after the model has been trained, measurements collected by a well operator (e.g., gamma, resistivity, neutron, density, compressional, shear, temperature, torque, differential and standpipe pressure, mud weight, and/or the like) and, in some embodiments, parameters derived from the measurements (Young's modulus, Poisson's ratio, and/or the like), are provided as inputs to the model, and the parameters output by the model, including parameters at various depth points and in a reference window around each depth point, such is in XY space and/or Z space, are used to generate high-resolution earth models. Input parameters may be continuously measured and provided to the model to produce updated outputs so that an earth model can be updated in real-time.

Embodiments of the present disclosure constitute an improvement over conventional techniques for generating earth models Conventional techniques typically lack sufficient training data. Multi-variant linear statistical approaches have been used and applied to seismic facies recognition, but these techniques lack resolution. On the other hand, techniques described herein involve generating high-resolution earth models using machine learning models trained using attributes from each of a plurality of depth points along with adjacent waveforms in a plurality of directions with respect to each depth point. Using a variety of flexible inputs, including well logs, seismic volumes (both pre and post-stack), geologic maps, etc, along with adjacent waveforms, allows for a more comprehensive picture of a reservoir to be used in determining output parameters. Depending on the desired output, additional petrophysical analysis and rock physics modeling may be performed. In particular embodiments, a reference window (e.g., of 100 feet or another size) above and below each depth point is used to compare waveforms, rather than utilizing only a single waveform at each depth point as has conventionally been done. Furthermore, the reference window may be expanded to include waveforms surrounding each depth point in XY space in addition to a vertical window in Z space. As such, attributes at a given depth point are supplemented with adjacent waveform data to provide a higher resolution.

For example, if the desired output is water saturation (Sw), initial water saturation information from a plurality of depth points in one or more wells may be included in the training, along with adjacent waveform data in a plurality of directions for each depth point. Additionally, synthetic log data may be used to further populate sparse training data. For example, synthetic logs may be generated using techniques described in U.S. Pat. No. 10,242,312, entitled “SYNTHETIC LOGGING FOR RESERVOIR STIMULATION,” filed Jun. 6, 2014, and co-pending U.S. patent application Ser. No. 16/273,383, entitled “REAL-TIME SYNTHETIC LOGGING FOR OPTIMIZATION OF DRILLING, STEERING, AND STIMULATION,” filed on Feb. 12, 2019, the contents of which are incorporated herein in their entirety. Seismic data may be converted to time using conventional depth to time conversion algorithms and then trained at the well and synthetic well locations. A stratigraphic parameter calculation can be performed to create a stratigraphic model that is tied to horizon picks, structure maps and isopach maps, etc. In certain embodiments, a matrix is built that incorporates all available input data. These matrix parameters are then used as inputs for a supervised neural network.

The quick, cost effective, higher resolution and more reliable ties at well control points (also referred to as depth points) help enhance and “operationalize” earth models for any organization. In certain reservoirs, the earth model can be used to optimize well placement, and as the well is being drilled, the earth model can be updated to ensure the well is landed in and staying in the desired zone. As the models are continuously updated, techniques described herein are dynamic and not static like traditional inversions. The models can be quickly updated when new well information becomes available without the requirement to re-run the entire process. The eventual product of techniques described herein may be a geocellular model that may be directly input into reservoir simulators.

Conventional inversion methods can be band limited and several calibration constraints placed on seismic requires more human interaction for interpretation, which directly affects the result. Techniques described herein increase bandwidth, which is directly proportional with the resolution. Seismic resolution is a measure of how large a structure can be seen in seismic. Reservoirs cannot be discerned when their thickness is below seismic resolution, which is overcome with the solutions described herein.

Use of techniques described herein provides companies with the ability for improved decision making regarding whether a given area is worthy of development, deciding on a well placement and well path, adjusting drilling mud weights to avoid wellbore instability events and optimizing well completion designs. Decisions made based on high-resolution earth models generated and updated in real-time using techniques described herein can significantly improve the human and environmental safety of drilling operations as well as the initial production rates and estimated ultimate recovery for an operator's well program across a project area. These are all important decisions with potential impacts in the millions to billions of dollars.

Utilizing an accurate, high-resolution geomechanical earth model ensures that these key decisions are made optimally. Embodiments of the present disclosure incorporate highly supervised machine learning models that greatly reduce risk and uncertainty critical to making strategic, tactical decisions, and calculating value of information. Additional properties of interest can be derived from databases with calibration points. Cross validation using blind well methods decreases the chances of the network being over-trained and ensures the quality of the method.

The AI inversion techniques, such as those based on AI layered neural network technology, described herein are driven by data, and are not restricted by a convolutional model biased by human interference. Furthermore, embodiments of the present disclosure reduce the overall timeline and budget of an earth modeling project.

The ability to see earth properties in real-time using techniques described herein allows for adjustments in mud weight to avoid pressure kicks, which can lead to blowouts, and re-orient course to avoid pressure pockets or faults, both of which have safety and financial consequences, respectively. Furthermore, updating the earth model in real-time or near real-time according to embodiments of the present disclosure for a given radius, such as 0.5 to 1 mile, around the latest real-time log (or Q Log) measurement depth allows the driller to see these earth properties ahead of the drill bit. This is an improvement over conventional techniques in which earth models may take weeks to months to update, and where the driller cannot see ahead of the bit.

In particular embodiments, an earth model is created by finding non-linear ties between well log data and a seismic image volume in a statistical fashion. The process preserves realistic output without the specification of somewhat arbitrary constraints as in done in traditional seismic inversion, as the machine learning model is able to learn the underlying physics as a part of the network training process.

Machine learning model training can be flexible in terms of the type of data that is input and output. Certain embodiments involve a workflow that is based on traces extracted along wellbores where control data (density and compressional slowness logs) have been recorded or derived synthetically. In addition to the well and seismic data, interpreted maps such as isopachs, average porosity, depth, etc. as derived from well logs can be included as constraints during the training process. This allows the inversion not only to discover the inherent physics at play but also to allow the intuitions of the interpreter to guide the output. In one example, isopach, depth, and average porosity maps interpreted from wells, wells logs with density/sonic slowness, and wells logs with density/neural network-derived synthetic sonic are used to train a machine learning model.

As with seismic inversion, the model generation process is non-unique depending upon the network architecture and optimization requirements. In certain embodiments, more wells are included in the process than just those with sonic density, greatly increasing statistics.

Prior to interpretation, output volumes may be attached to a structural model as accurately as possible so that faults and dip variance can be assessed at the same time as stratigraphic variance for well planning. Depth conversion is completed by the use of a machine learning model that incorporates all formation tops from available wells and seismic horizon picks, including adjacent waveforms in a vertical and/or horizontal reference window around each depth point, to predict the formation tops for the output volume. The surface ties wells explicitly while preserving structure (such as local synclines, anticlines, and faults) from the seismic images.

Using additional information to constrain the model allows it to become less susceptible to noise or artifacts (e.g., earth noise, poor migration velocities, acquisition footprint, etc.) in the seismic data than traditional inversion, in which those artifacts would be interpreted as representing real reservoir physics.

It is further noted that, since techniques described herein may be statistically based, it is possible to extract an inversion for any log property that is correlated to the other log properties and to the seismic data. Thus, it is possible, for instance, to generate a Gamma Ray volume output since input logs and seismic are correlated with Gamma Ray.

Techniques described herein may involve outputting data at the log scale (e.g., 6 inches). Using density as a proxy for porosity, optimal locations in a lower reservoir zone are easily high graded for well placement. In addition to AI-based inversion, other technologies such as optimal perforation placement based similar stress from synthetic horizontal logs may be applied to wells.

Another additional benefit of techniques described herein is the dramatic simplification of a standard earth modeling workflow. The operational outcome of techniques described herein includes a shorter and less labor-intensive project lifespan, with reduced need for specialized software. In short, embodiments of the present disclosure have been shown to be a potential enabler for timely high-resolution earth model generation for day-to-day decision making regarding acreage acquisition, well placement, field development, and the like.

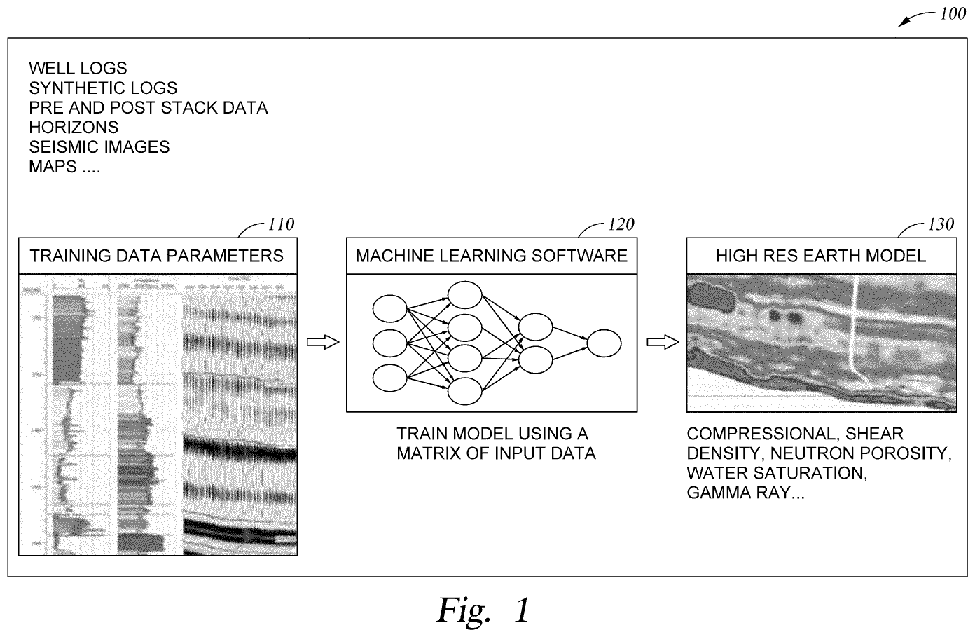

FIG. 1 illustrates an example 100 related to high-resolution earth modeling using artificial intelligence.

Training data parameters 110 are based on a variety of training inputs, such as well logs, synthetic logs, pre and post stack data, horizons, seismic images, maps, and the like, and include labels indicating values for various output parameters of the model (e.g., including geomechanical, wellbore stability, pore pressure, and/or petrophysical attributes), such as compressional, shear, density, neutron porosity, porosity, water saturation, gamma ray, resistivity, elastic properties such as Young's modulus and Poisson's ratio, and the like. In certain embodiments, training data parameters 110 include parameters at a plurality of depth points along with adjacent waveforms for each depth point in a plurality of directions, such as within a reference window in XY and/or Z space (e.g., upward, downward, left, right, forward, and/or backward).

Machine learning model 120 is trained based on training data parameters 110, such as by using a matrix of input data. Machine learning model 120 may comprise a plurality of layers with interconnected nodes.

Once trained, machine learning model 120 is used to produce a high-resolution earth model 130, which models various parameters output by machine learning model 120, such as compressional, shear, density, neutron porosity, porosity, water saturation, gamma ray, and the like. Parameters may be output by machine learning model 120 in real-time or near real-time, and may include parameters at various depth points as well as adjacent parameters (e.g., waveforms) in a plurality of directions with respect to each depth point. As such, techniques described herein provide real-time properties both at the bit position and ahead of the bit position. Accordingly, a high-resolution earth model can be determined and continuously updated, allowing improved decisions to be made in real-time with respect to a given well.

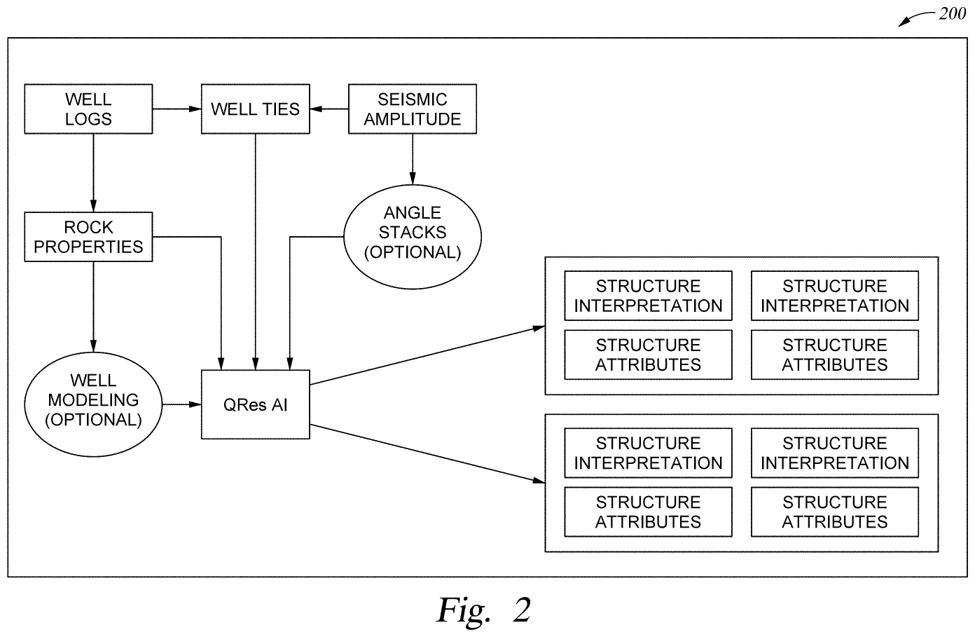

FIG. 2 illustrates another example 200 related to high-resolution earth modeling using artificial intelligence.

In example 200, well logs are used to determine rock properties, on which well modeling is optionally performed. The well logs and seismic amplitude are used to determine well ties. The seismic amplitude is optionally used to determine angle stacks. The rock properties, optionally the well modeling and angle stacks, the seismic amplitude, and/or the well ties are provided to the QRes AI (e.g., a machine learning model). The machine learning model outputs structure interpretation, spectral decomposition, structure attributes, seismic trace facies, P-impedance, S-impedance, and impedance derivatives.

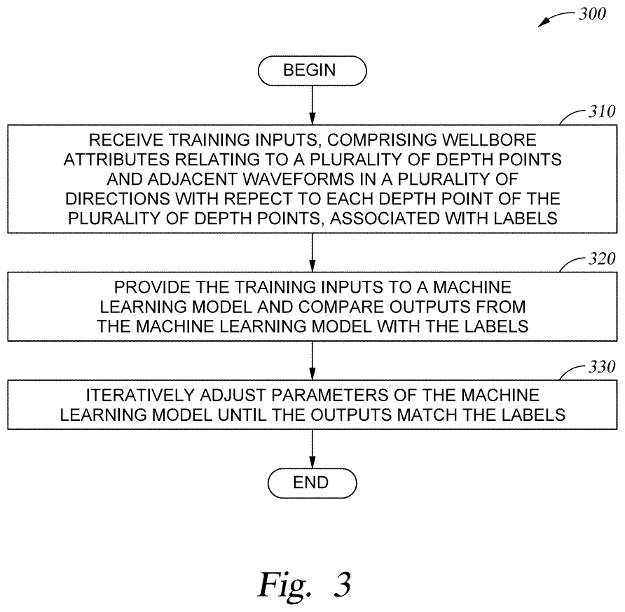

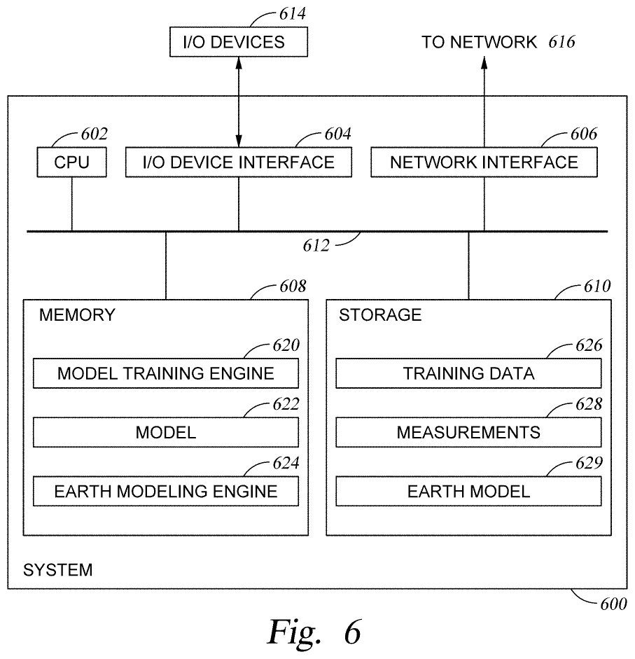

FIG. 3 illustrates example operations 300 for training a model related to high-resolution earth modeling. For example, operations 300 may be performed by \ model training engine 622 of FIG. 6, as described below.

Operations 300 begin with step 310, where training inputs, comprising wellbore attributes relating to a plurality of depth points and adjacent waveforms in a plurality of directions with respect to each depth point of the plurality of depth points, associated with labels are received. For example, the training inputs may include one or more attributes related to a wellbore that have been measured or determined based on measured data, and the labels may comprise different properties related to the wellbore that are to be output by a machine learning model. Attributes for each depth point are associated with waveform data in a reference with respect to the depth point. The plurality of directions may include, for example, up and down (e.g., in Z space), and/or left, right, forward and backward (e.g., in XY space). It is noted that “labels” are only included as one example for training a machine learning model, and other techniques may be used to train a machine learning model based on attributes at depth points and adjacent waveforms.

At step 320, the training inputs are provided to a machine learning model, and outputs from the machine learning model are compared with the labels. For example, the machine learning model may be an artificial neural network, deep neural network, deep belief network, recurrent neural network, convolutional neural network, or the like. It is noted that these are only included as examples and other types of machine learning models may be used with techniques described herein.

At step 330, parameters of the machine learning model are iteratively adjusted until the outputs match the labels. Parameters adjusted during training may include, for example, hyperparameters related to numbers of iterations, numbers of hidden layers and nodes, weights, and connections between layers and nodes, as well as functions associated with nodes.

Once the outputs match the labels for all training data, the trained machine learning model is used as part of a process for determining high-resolution earth models as described herein.

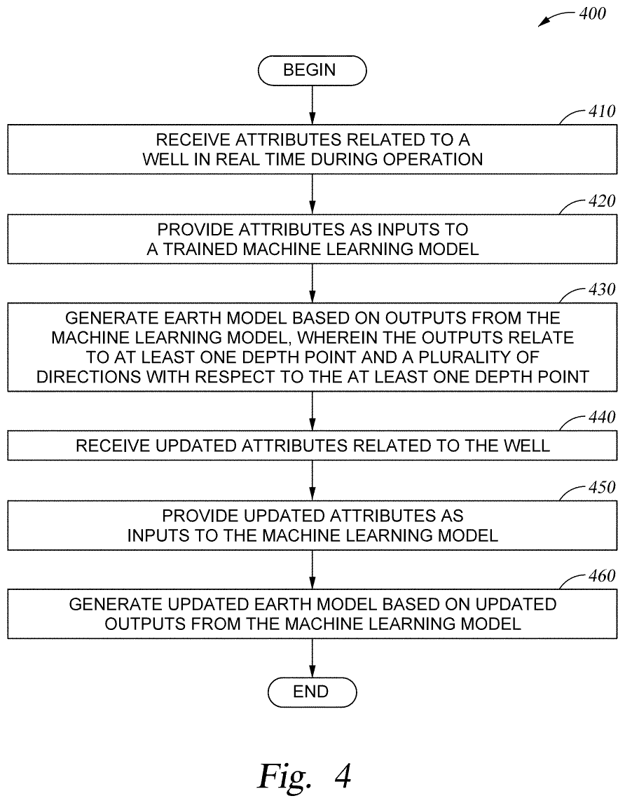

FIG. 4 illustrates example operations 400 for using a trained model for high-resolution earth modeling.

Operations 400 begin at step 410, where attributes related to the well are received in real time during operation. In certain embodiments, the attributes include gamma, temperature, torque, differential and standpipe pressure, mud weight, and/or the like, and are captured by various sensors during a drilling or reservoir stimulation operation. In some embodiments, the attributes also include attributes derived from measurements, such as synthetic logs.

At step 420, the attributes are provided as inputs to a trained machine learning model. In certain embodiments, the attributes (and, in some cases, other values derived from the attributes) are provided to an input layer of the machine learning model, which may have been trained as described above with respect to operations 300 of FIG. 3.

At step 430, an earth model is generated based on outputs from the machine learning model, wherein the outputs relate to at least one depth point and a plurality of directions with respect to the at least one depth point. For example, the machine learning model may output one or more parameters such as geomechanical, wellbore stability, pore pressure, and/or petrophysical attributes, and/or the like from an output layer. The parameters output by the model may include parameters with respect to the at least one depth point and parameters related to a plurality of directions with respect to the at least one depth point, such as up, down, left, right, forward, and/or backward. The earth model is a high-resolution earth model due to the use of a machine learning model to process a wide variety of inputs that provide a detailed picture of the well.

At step 440, updated attributes related to the well are received. In some embodiments, measurements are continuously captured by various sensors during the drilling or reservoir stimulation operation. In certain embodiments, other parameters are determined based on the measurements.

At step 450, the updated attributes are provided as inputs to the machine learning model. In some embodiments, updated attributes (and, in some cases, other values derived from the attributes) are continuously provided to the input layer of the machine learning model.

At step 460, an updated earth model is generated based on updated outputs from the machine learning model. For example, the updated outputs may be new values for the outputs of step 430.

The earth model may be used to optimize well placement, and as the well is being drilled, the earth model is dynamically updated to ensure the well is landed in and staying in the desired zone.

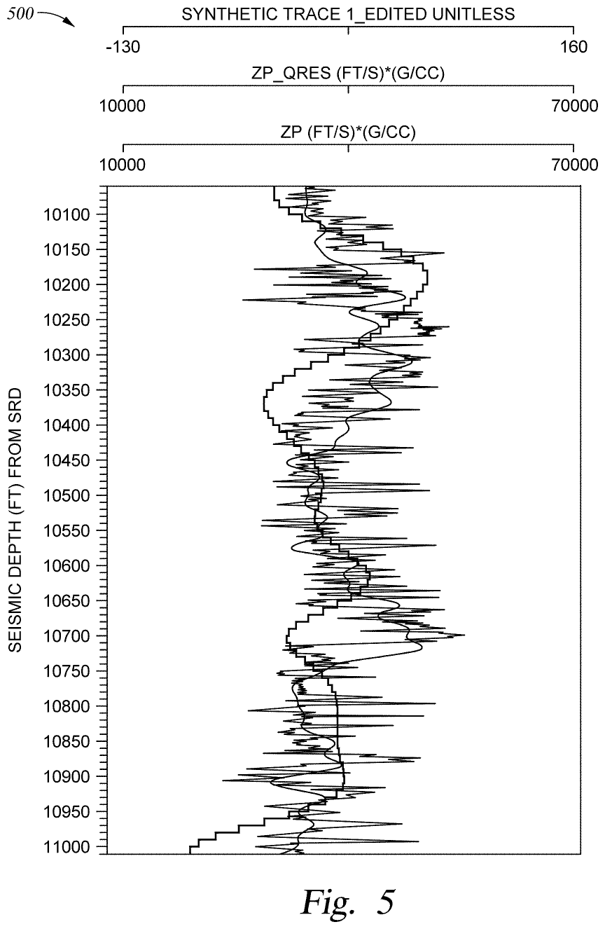

FIG. 5 illustrates an example 500 of improved results obtained by using embodiments of the present disclosure for high-resolution earth modeling as compared to conventional techniques.

Example 500 shows that the impedance volume output from AI inversion techniques described herein ties explicitly to the well log. The resolution provided in the volume, averaging a dominant frequency around 120 Hz, is near the well log bandwidth, and much higher than conventional inversion results. The conventionally processed elastic inversion results 530, with a dominant frequency 25 Hz, do not match the well log 510 as closely as the AI inversion results 520 described herein because of the difference in resolution.

Vertical resolution can be calculated from the wavelength formula:

λ=V/F

where λ is wavelength (ft), V is seismic velocity (ft/s) and F is seismic frequency (Hz). The vertical seismic resolution is calculated by:

Resolution=λ/8

The resolution calculated from AI-based inversion is less than 10 feet. However, conventional inversion resolution is greater than 50 feet. In seismic data, objects can be detected if it is larger than the vertical resolution. The AI-based inversion technique greatly increases the frequency for detecting and defining the reservoirs by revealing a significant amount of detail. The output in depth may be in Society of Exploration Geophysicists (SEG) Y format with a sampling interval of 6 inches. In most calculations, the dominant seismic frequency is used when calculating seismic resolution.

Seismic amplitudes typically do not correlate directly with the rock properties and geological structures. It is noted that using the AI-based inversion techniques described herein for thin beds and complex reservoirs can be beneficial. For example, results of conventional techniques generally follow the geological structure but lack the resolution of the actual well measurements, while the AI-based inversion result yields much greater detail extending the significant value from the well information across the section.

Conventional inversion methods are lower resolution than techniques described herein due to the differences in resolution of the input seismic data. Distinctions between conventional techniques and embodiments of the present disclosure are significant because AI-based inversion using machine learning models removes potential bias from the analysis and adds more control points.

FIG. 6 illustrates an example computer system 600 used for real-time synthetic logging for optimized drilling of a reservoir, according to embodiments of the present disclosure. As shown, the system 600 includes a central processing unit (CPU) 602, one or more I/O device interfaces 604 that may allow for the connection of various I/O devices 614 (e.g., keyboards, displays, mouse devices, pen input, etc.) to the system 600, network interface 606, a memory 608, storage 610, and an interconnect 612.

CPU 602 may retrieve and execute programming instructions stored in the memory 608. Similarly, the CPU 602 may retrieve and store application data residing in the memory 608. The interconnect 612 transmits programming instructions and application data, among the CPU 602, I/O device interface 604, network interface 606, memory 608, and storage 610. CPU 602 is included to be representative of a single CPU, multiple CPUs, a single CPU having multiple processing cores, and the like. Additionally, the memory 608 is included to be representative of a random access memory. Furthermore, the storage 610 may be a disk drive, solid state drive, or a collection of storage devices distributed across multiple storage systems. Although shown as a single unit, the storage 610 may be a combination of fixed and/or removable storage devices, such as fixed disc drives, removable memory cards or optical storage, network attached storage (NAS), or a storage area-network (SAN). Storage 610 includes training data 62, which is used by model training engine 620 to train model 622. Storage 610 also includes measurements 628, which are captured during drilling or reservoir stimulation operations, and are used by earth model engine 624 to provide inputs to model 622. Earth 629 is a high resolution earth model that is generated and dynamically updated in real-time by earth model engine 624 based on outputs from model 622.

As shown, memory 608 includes a model training engine 620, which may perform operations described herein related to training a machine learning model, such as operations 300 of FIG. 3. Model 622 generally comprises a machine learning model that is used as part of a process for high-resolution earth modeling as described herein. Earth model engine 624 generally performs operations related to generating and updating high-resolution earth models as described herein, such as by providing inputs to model 622 based on measurements 628 and generating high-resolution earth model 629 based on outputs from model 622. For example, earth model engine 624 may perform operations 400 of FIG. 4. Model training engine 620 and/or earth model engine 624 in memory 608 may communicate with other devices (e.g., components of a drilling system) over a network 616 (e.g., the Internet, a local area network, or the like) through network interface 606 (e.g., in order to receive measurements, provide output and instructions, and the like).

The preceding description is provided to enable any person skilled in the art to practice the various embodiments described herein. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

A processing system may be implemented with a bus architecture. The bus may include any number of interconnecting buses and bridges depending on the specific application of the processing system and the overall design constraints. The bus may link together various circuits including a processor, machine-readable media, and input/output devices, among others. A user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer-readable medium. Software shall be construed broadly to mean instructions, data, or any combination thereof, whether referred to as software, firmware, middleware, microcode, hardware description language, or otherwise. Computer-readable media include both computer storage media and communication media, such as any medium that facilitates transfer of a computer program from one place to another. The processor may be responsible for managing the bus and general processing, including the execution of software modules stored on the computer-readable storage media. A computer-readable storage medium may be coupled to a processor such that the processor can read information from, and write information to, the storage medium. In the alternative, the storage medium may be integral to the processor. By way of example, the computer-readable media may include a transmission line, a carrier wave modulated by data, and/or a computer readable storage medium with instructions stored thereon separate from the wireless node, all of which may be accessed by the processor through the bus interface. Alternatively, or in addition, the computer-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module, it will be understood that such functionality is implemented by the processor when executing instructions from that software module.

1. A method, comprising:
receiving training data, comprising:
wellbore attributes relating to a plurality of depth points; and
adjacent waveform data relating to a first plurality of directions with respect to each depth point of the plurality of depth points;
providing at least a subset of the training data as inputs to a machine learning model;
receiving outputs from the machine learning model based on the inputs; and
iteratively adjusting parameters of the machine learning model based on the outputs and the training data.

2. The method of claim 1, further comprising:
receiving attributes related to a well in real time;
providing the attributes as inputs to the machine learning model; and
generating an earth model based on outputs from the machine learning model, wherein the outputs relate to at least one depth point and a second plurality of directions with respect to the at least one depth point.

3. The method of claim 2, further comprising:
receiving updated attributes related to the well;
providing the updated attributes as inputs to the machine learning model; and
generating an updated earth model based on updated outputs from the machine learning model.

4. The method of claim 1, wherein the first plurality of directions comprises one or more directions selected from a list comprising: up, down, left, right, forward, and backward.

5. The method of claim 1, wherein the wellbore attributes comprise one or more of: gamma, resistivity, neutron, density, compressional, shear, or elastic properties.

6. The method of claim 1, wherein the machine learning model comprises a neural network.

7. The method of claim 1, wherein the adjacent waveform data corresponds to a given radius with respect to each depth point of the plurality of depth points.

8. A system, comprising: one or more processors; and a memory comprising instructions that, when executed by the one or more processors, cause the system to perform a method, the method comprising:
receiving training data, comprising:
wellbore attributes relating to a plurality of depth points; and
adjacent waveform data relating to a first plurality of directions with respect to each depth point of the plurality of depth points;
providing at least a subset of the training data as inputs to a machine learning model;
receiving outputs from the machine learning model based on the inputs; and
iteratively adjusting parameters of the machine learning model based on the outputs and the training data.

9. The system of claim 8, wherein the method further comprises:
receiving attributes related to a well in real time;
providing the attributes as inputs to the machine learning model; and
generating an earth model based on outputs from the machine learning model, wherein the outputs relate to at least one depth point and a second plurality of directions with respect to the at least one depth point.

10. The system of claim 9, wherein the method further comprises:
receiving updated attributes related to the well;
providing the updated attributes as inputs to the machine learning model; and
generating an updated earth model based on updated outputs from the machine learning model.

11. The system of claim 8, wherein the first plurality of directions comprises one or more directions selected from a list comprising: up, down, left, right, forward, and backward.

12. The system of claim 8, wherein the wellbore attributes comprise one or more of: gamma, resistivity, neutron, density, compressional, shear, or elastic properties.

13. The system of claim 8, wherein the machine learning model comprises a neural network.

14. The system of claim 8, wherein the adjacent waveform data corresponds to a given radius with respect to each depth point of the plurality of depth points.

15. A non-transitory computer-readable medium comprising instructions that, when executed by one or more processors of a computing system, cause the computing system to perform a method, the method comprising:
receiving training data, comprising:
wellbore attributes relating to a plurality of depth points; and
adjacent waveform data relating to a first plurality of directions with respect to each depth point of the plurality of depth points;
providing at least a subset of the training data as inputs to a machine learning model;
receiving outputs from the machine learning model based on the inputs; and
iteratively adjusting parameters of the machine learning model based on the outputs and the training data.

16. The non-transitory computer-readable medium of claim 15, wherein the method further comprises:
receiving attributes related to a well in real time;
providing the attributes as inputs to the machine learning model; and
generating an earth model based on outputs from the machine learning model, wherein the outputs relate to at least one depth point and a second plurality of directions with respect to the at least one depth point.

17. The non-transitory computer-readable medium of claim 16, wherein the method further comprises:
receiving updated attributes related to the well;
providing the updated attributes as inputs to the machine learning model; and
generating an updated earth model based on updated outputs from the machine learning model.

18. The non-transitory computer-readable medium of claim 15, wherein the first plurality of directions comprises one or more directions selected from a list comprising: up, down, left, right, forward, and backward.

19. The non-transitory computer-readable medium of claim 15, wherein the wellbore attributes comprise one or more of: gamma, resistivity, neutron, density, compressional, shear, or elastic properties.

20. The non-transitory computer-readable medium of claim 15, wherein the machine learning model comprises a neural network.
